(19) United States
(12) Patent Application Publication
(10) Pub. No.: US 2010/0116518 A1
(43) Pub. Date: May 13, 2010

(54) COUPLING ARRANGEMENT FOR COUPLING ROCK DRILL SHANK

(75) Inventors: Mauri Esko, Ikaalinen (FI); Markku Keskiniva, Ylojarvi (FI); Juha Piispanen, Tampere (FI); Aimo Helin, Tampere (FI)

Correspondence Address: DRINKER BIDDLE & REATH (DC), 1500 K STREET, N.W., SUITE 1100, WASHINGTON, DC, 20005-1209, US

(73) Assignee: SANDVIK MINING AND CONSSTRUCTION OY, TAMPERE (FI)

(21) Appl. No.: 12/597,312

(22) PCT Filed: Apr. 24, 2008
(86) PCT No.: PCT/FI08/50219

§ 371 Date: Jan. 5, 2010

(30) Foreign Application Priority Data
Apr. 25, 2007 (FI) 20075289

(51) Int. Cl. E21B 6/00; B25D 17/08

(52) U.S. Cl. 173/105

(57) ABSTRACT

The invention relates to a coupling arrangement for coupling a drill shank of a rock drill unrotatably but axially movably. The coupling arrangement comprises power transmission members between the surfaces of the drill shank and the rotation bushing, which transmission members rotate along the surfaces, as the drill shank moves longitudinally to the rotation bushing, and transmit the rotation torque from the rotation bushing to the drill shank.

### BACKGROUND OF THE INVENTION

The invention relates to a coupling arrangement for coupling a drill shank of a rock drill unrotatably but axially movably with respect to a rotation bushing locating around the drill shank while the shank is mounted in place in the rock drill and rotating the drill shank, in which arrangement the rotation bushing comprises, in relation to the direction of rotation, at least one power transmission surface substantially in the direction of the rotation axis, transverse to the direction of rotation and facing the direction of rotation, and correspondingly, the drill shank comprises an equal number of power reception surfaces substantially in the same direction and facing from the power trans-mission surfaces to the direction of rotation, whereby the rotation torque is transferred during rotation from the rotation bushing through the power trans-mission and power reception surfaces to the drill shank.

In rock drilling apparatuses a drill rod is rotated during drilling with a separate rotation motor, which in most cases is a hydraulic motor. The rotation motor rotates a separate coupling piece, typically a rotation bushing. The rotation bushing, in turn, rotates a drill shank, to which a drill rod is coupled with a standard threaded joint and in which percussion pulses required in drilling are induced with a percussion piston of the rock drill or a like mechanism.

Typically, the coupling between the rotation bushing and the drill shank is implemented by using axial grooving in the rotation bushing, and correspondingly, in the drill shank, whereby they engage unrotatably but axially movably with one another. In that case the lateral surfaces of the grooves act as transmission and reception surfaces of the rotation torque.

A problem with the current solutions is that the lateral surfaces of the grooves rub against one another during drilling, while the rotation torque of the rotation motor presses the surfaces against one another. This results in heating and deteriorating of the surfaces. The larger the rotation torque to be transmitted, the axial movement between the drill shank and the rotation bushing as well as the percussion frequency of the drill, the higher the friction force acting between the surfaces.

Various solutions have been proposed to solve this problem. One method employs oblique grooving, whereby as a result of a translational movement produced by an impact, the surfaces disengage and the movement takes place without friction between the surfaces. On the other hand, in this solution a movement produced by a reflection pulse causes a reversed phenomenon, whereby a reflected compression wave causes a percussion-like load spike on the contact surfaces. Consequently, as both friction and load spike affect the surfaces, the contact surfaces may get damaged mechanically.

### BRIEF DESCRIPTION OF THE INVENTION

The object of the present invention is to provide a coupling arrangement by which current problems may be considerably reduced.

The arrangement of the invention is characterized in that the arrangement includes power transmission members between each power transmission surface and a corresponding power reception surface, which power transmission members, as the drill shank moves in relation to the rotation bushing in the longitudinal direction thereof, rotate along the power trans-mission surface and correspondingly along the power reception surface, and through which the rotation torque is transferred from the power transmission surface to the power reception surface.

The basic idea of the invention is that between the power transmission and power reception surfaces of the rotation bushing and the drill shank there are mounted transmission members serving as bearings, which rotate along the surfaces, as the drill shank and the rotation bushing move longitudinally with respect to one another. The basic idea of an embodiment of the invention is that in the rotation bushing and in the drill shank there are provided a plurality of mutually aligned grooves and that in the grooves there are placed balls that act as transmission members and, on one hand, transmit the rotation torque from the rotation bushing to the drill shank, and, on the other hand, allow the axial movement between them substantially without sliding friction.

The invention has an advantage that when rolling transmission members, such as balls, are used between the rotation bushing and the drill shank, there are no mutually abrasive surfaces in the rotation bushing and the drill shank. Further, a sufficient number of rolling transmission members in each groove are capable of transmitting a required rotation torque without excessive surface pressure, whereby mechanical damage will not occur. Still further, as the drill shank moves in its longitudinal direction with respect to the rotation bushing, the transmission members roll against the counterpart surfaces of the rotation bushing and the drill shank, whereby at its most advantageous all friction is substantially just rotation friction.

### BRIEF DESCRIPTION OF THE DRAWINGS

In the following, the invention will be described in greater detail in connection with the attached drawings, in which

FIG. 1 is a schematic view of a conventional rock drill,

FIG. 2 is a schematic view of a front end of the rock drill partly cut open and provided with a coupling arrangement of the invention,

FIGS. 3a to 3c are schematic views of a front end of the rock drill and some details of the solution, cut along line A-A of FIG. 2,

FIGS. 4a and 4b show some other embodiments of the invention cut open,

FIGS. 5a and 5b show still some other embodiments of the invention, and

FIG. 6 is a schematic view of yet another embodiment of the invention.

### DETAILED DESCRIPTION OF SOME EMBODIMENTS OF THE INVENTION

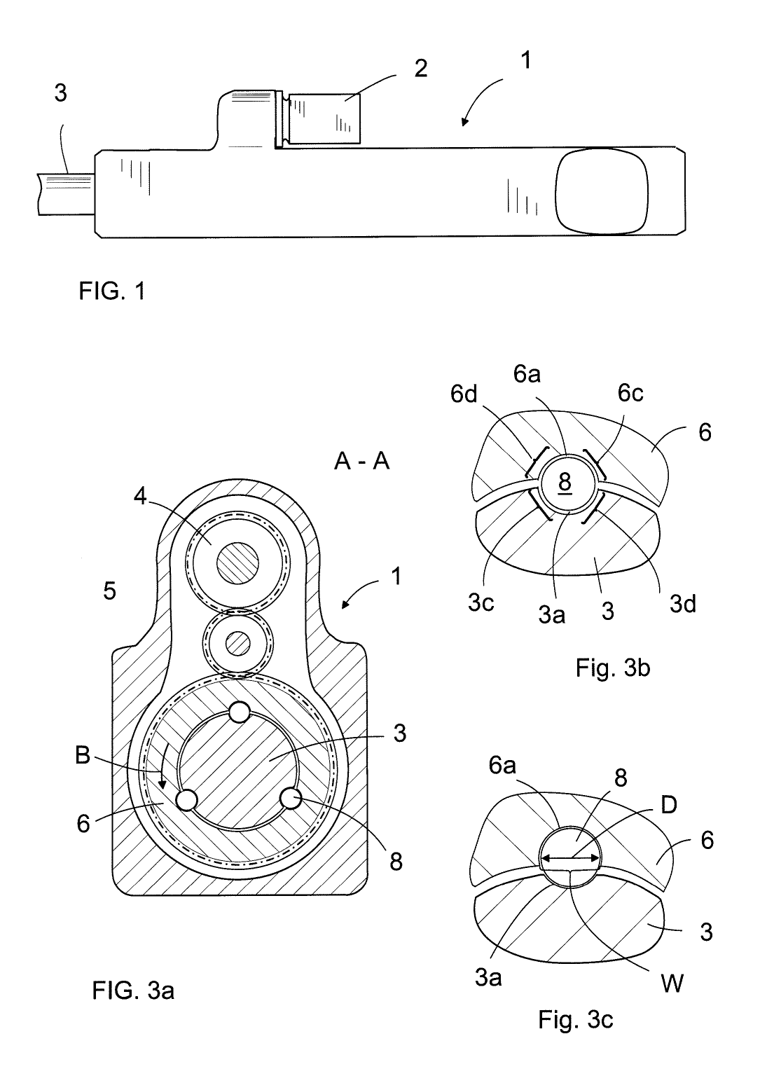

In FIGS. 1 to 6, like reference numerals refer to like parts, except when the embodiment in some respects differs from the others. Thus, like parts have not been separately provided with reference numerals in all figures, unless essential for the sake of clarity.

FIG. 1 is a schematic view of a rock drill 1. It includes a rotation motor 2 that is coupled in a manner known per se to rotate a drill shank 3 through a separate, not visible, rotation bushing. A drill rod and a drill bit are coupled to the drill shank 3 in a manner known per se using threads (not shown).

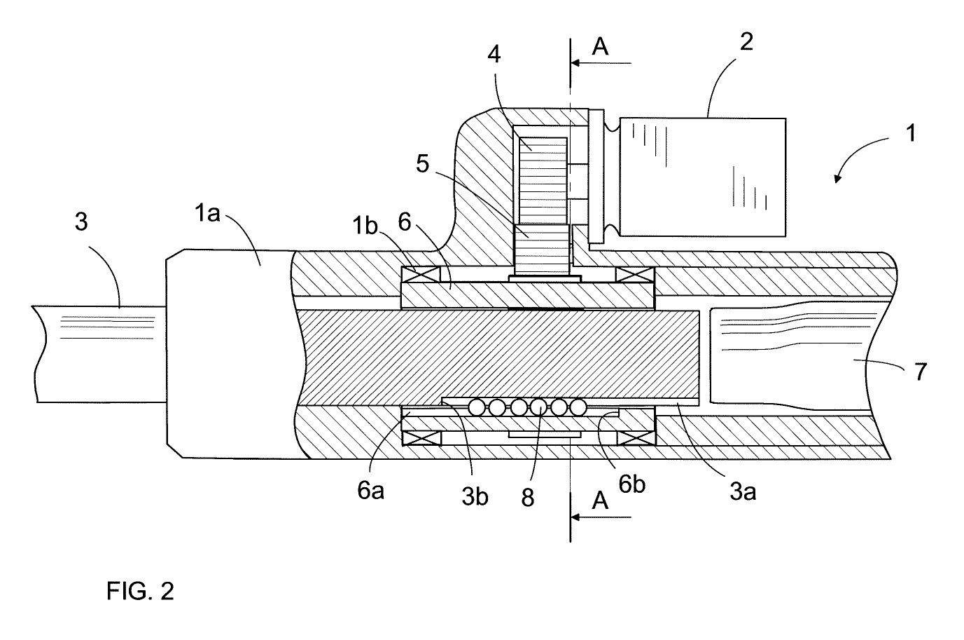

FIG. 2 shows a front end of the rock drill cut open in the longitudinal direction thereof. It comprises a body 1a, onto which other parts are mounted. It shows how a toothed wheel 4 on the axis of the rotation motor 2 is engaged through a transmission gear 5 to rotate a rotation bushing 6 that rotates on schematically shown bearings 1b. The rotation bushing 6, in turn, is located around the drill shank 3. A percussion piston 7 known per se, of which only the end is seen here, strikes on the head of the drill shank 3 when the rock drill is running and makes the drill shank 3 and the drill rod connected thereto, known per se and not shown here, move towards the rock to be drilled, i.e. to the left in the situation shown in FIG. 2.

In the solution of FIG. 2, the outer diameter of the drill shank 3 is slightly smaller than the inner diameter of the rotation bushing 6, and consequently they are not in direct contact with one another. Instead, in the drill shank 3 and in the rotation bushing 6 there are provided grooves 3a and 6a such that they are radially aligned. In accordance with an embodiment, there are three grooves, whereby they are symmetrically spaced at 120-degree intervals on the outer surface of the drill shank, and correspondingly, on the inner surface of the rotation bushing 6. The grooves 3a, 6a are further provided with balls serving as transmission members 8 and being substantially equal in size with the grooves, and they keep the drill shank 3 and the rotation bushing 5 substantially aligned in the radial direction. The number of balls may be selected in accordance with the rotation torque to be transmitted and the diameter of the drill rod/drill bit.

As shown in FIG. 2, at one end of the grooves of the rotation bushing and in a corresponding manner of the drill shank there are shoulders 3b and 6b, respectively, which prevent the balls from falling off. Thus, the shoulder 6b of the rotation bushing 6 is located towards the rear end of the rock drill, i.e. towards the end on the side of the percussion piston 7, and the shoulder 3b of the drill shank is located towards the front end of the rock drill 1.

FIGS. 3a and 3b show schematically the front end and a detail of the solution cut along line A-A of FIG. 2. This shows how the rotation bushing 6 and the drill shank 3 comprise grooves 3a, 6a, respectively, that are mutually aligned in the circumferential direction and preferably symmetrically round the circumference. In the embodiment of FIGS. 3a and 3b the number of grooves 3a, 6a is three each. In this solution no surfaces are in contact with each other between the drill shank 3 and the rotation bushing 6, but they are only interconnected by means of the balls serving as transmission members 8 in the grooves and all forces are transmitted via the balls from the rotation bushing 6 to the drill shank 3 and vice versa. In cross section circular-arch-shaped parts 6c of semi-circular grooves 6a act as power transmission surfaces of the rotation bushing in normal direction of rotation, i.e. during drilling, and correspondingly, in cross section circular-arch-shaped parts 6d of grooves 6a act in the opposite direction of rotation, used for instance for unscrewing threads. Correspondingly, in cross section circular-arch-shaped parts 3c and 3d of semi-circular grooves 3a of the drill shank grooves 3a act as power reception surfaces.

FIG. 3c shows schematically an alternative detail of the solution of FIG. 3b, cut open along line A-A as shown in FIG. 2. In this case the shape of the grooves 6a provided in the rotation bushing 6 is such that its cross-sectional arch exceeds 180 degrees. The grooves 6a and the balls 8 are dimensioned such that the width W of the opening in the groove 6a facing the drill shank 3 is smaller than the diameter D of the balls serving as transmission members 8. As a result, the balls are not able to fall off the grooves 6a during mounting. Correspondingly, instead of rotation bushing 6, grooves of this kind may also be provided in the drill shank 3.

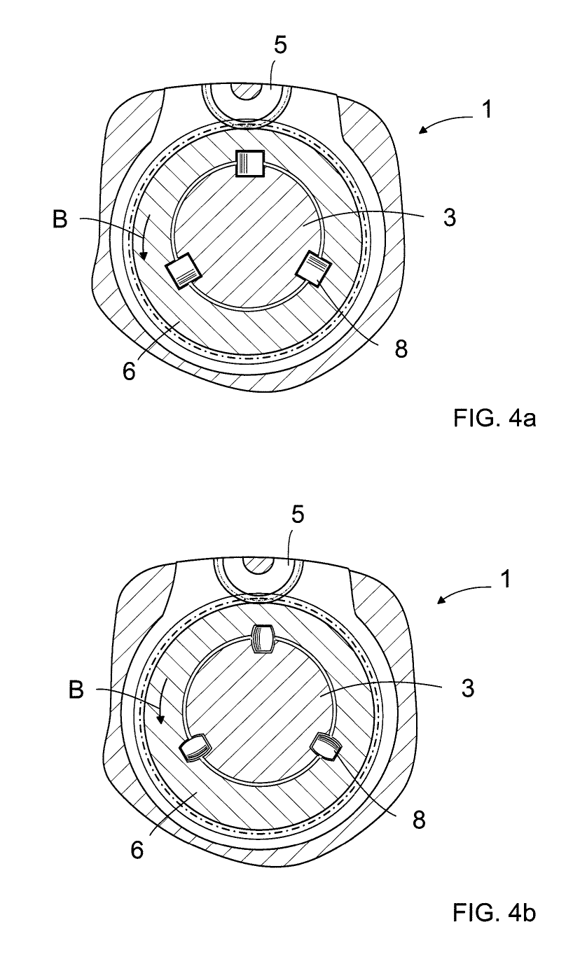

FIGS. 4a and 4b show schematically some other embodiments of the invention, in the same way as in FIG. 3 in partial cross section at line A-A.

FIG. 4 shows an embodiment in which cylindrical rollers are used as rolling transmission members 8 instead of round balls. In this embodiment the grooves 3a and 6a are substantially rectangular and the rolling transmission members 8, i.e. cylindrical rollers, are mounted axially transversely to the rotation axis of the drill shank 3, and correspondingly, the rotation bushing 6. Thus, the round surface of the rollers rolls along the sides of the grooves 3a and 6a that act as power transmission and power reception surfaces transmitting rotation torque from the rotation bushing to the drill shank. Naturally in this embodiment the end surfaces of the rollers may slide to some extent against the bottom of either one of the grooves, but because no considerable forces are transmitted in that direction, i.e. in the radial direction, no considerable sliding friction will occur, and consequently no substantial wear will appear either.

FIG. 4b shows yet another embodiment of the invention, in which rollers having curved surfaces are used as rolling transmission members 8, and correspondingly, surfaces of substantially their shape. In this case, rolling takes place along curved surfaces, and no considerable sliding and consequently sliding friction occurs.

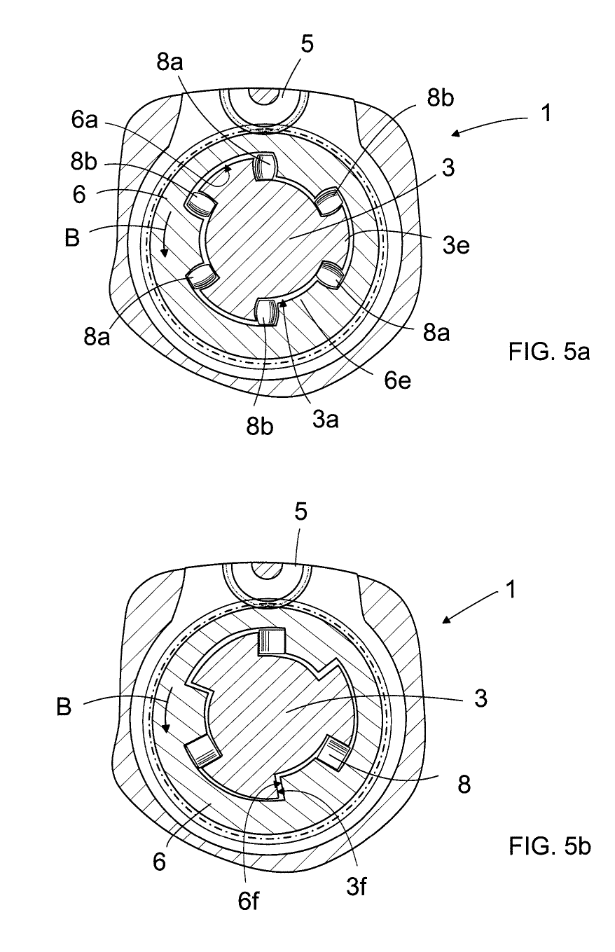

FIGS. 5a and 5b are schematic front views of other embodiments of the invention in the same way in cross section as in FIG. 3. In these embodiments the outer diameter of the drill shank 3 is larger than the inner diameter of the rotation bushing 6. Thus, both the drill shank 3 and the rotation bushing 6 comprise grooves 3a and 6a, which are so large in size that parts between the grooves of the drill shank and correspondingly of the rotation bushing, i.e. ridges 3e and 6e, fit in the grooves of one another.

FIG. 5a shows a solution in which the grooves 3a and 6a of the drill shank 3 and the rotation bushing 6 are dimensioned such that there will be space for transmission members 8a and 8b between the transmission surfaces thereof. In this embodiment there are transmission members in six spaces such that the transmission surface on either side of the transmission members 8a and 8b is substantially equal in height with the transmission member 8a or 8b. In this embodiment the power transmission from the rotation bushing to the drill shank takes place during drilling, and correspondingly, when rotation takes place in the opposite direction, with three transmission member sets 8a and 8b, whereby one transmission member set may comprise one or more transmission members between the same power transmission and power reception surfaces. Thus, the transmission members 8a transmit the rotation torque during drilling as rotation takes place in the direction of arrow B. Correspondingly, the transmission members 8b transmit the rotation torque as the drill rod is rotated backwardly, for instance, when it is dismounted.

FIG. 5b shows yet another embodiment of the invention. It comprises transmission members 8 in the direction of rotation only on one side between the drill shank and the rotation bushing, whereby they transmit the rotation torque to the drill shank 3 during normal drilling, i.e. as rotation takes place in the direction of arrow B. As the drill rod is dismounted, rotation takes place in the opposite direction, of course. As a whole, this is relatively insignificant as compared with the rotation associated with normal drilling, and therefore rotation in the opposite direction may employ the solution of FIG. 5b, in which the transmission of the rotation torque takes place in the dismounting stage from the rotation bushing to the drill shank by means of conventional sliding surfaces 3f and 6f known per se.

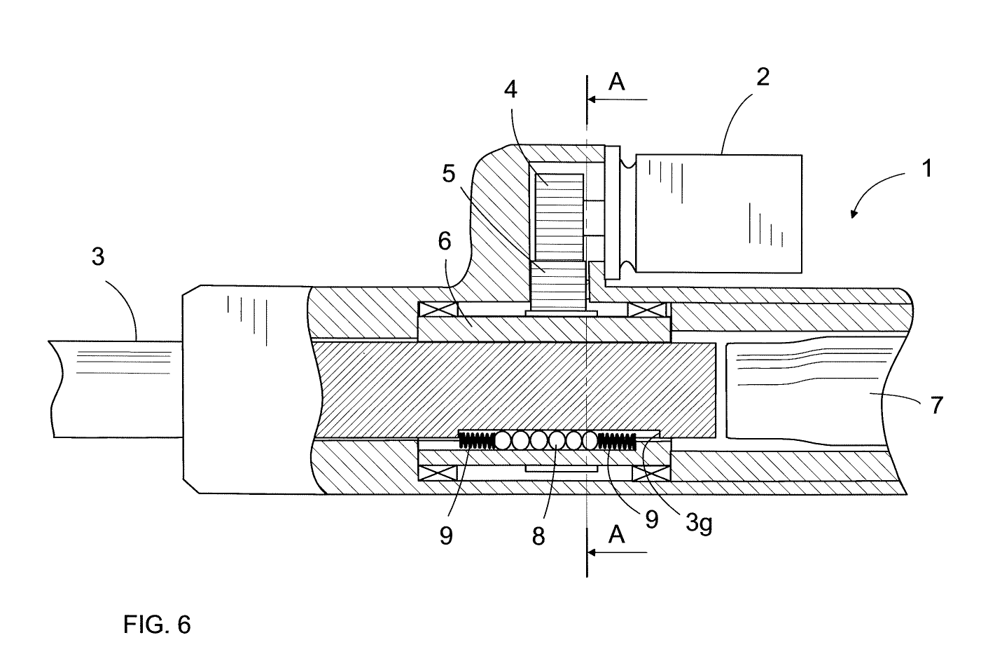

FIG. 6 shows yet another embodiment of the invention, the front end of the rock drill cut open in the longitudinal direction as in FIG. 2. This embodiment corresponds FIG. 2 in all other respects, but it shows a second shoulder 3g also at the end of the drill shank 3 on the side of the percussion piston 7, whereby the rotation bushing does not necessarily require a shoulder 6b. Alternatively, the shoulders may be in the rotation bushing 6 only. Further, it shows springs 9 that are placed on both sides of the balls acting as transmission members 8, between the balls and the shoulders 3b and 6b of the drill shank 3 and the rotation bushing 6, respectively. Mounted in this manner they push the transmission members 8 towards the centre of the space between the shoulders 3b and 6b. In a situation where only the drill shank or the rotation bushing 6 includes shoulders, the springs are naturally placed only between the shoulders of the drill shank 3 and the rotation bushing, respectively, and the transmission members 8.

The invention is described in the above specification and the drawings only by way of example, and it is not in any way restricted thereto. If desired, the number of grooves may vary and there may be one or more grooves. Because of symmetry and a tight contact surface, however, it is advantageous to have two or three pairs of power transmission and power reception surfaces with transmission members rolling therebetween. When there are used transmission members of cylindrical or some other shape that have a clearly defined, shape-related rotation axis, the grooves and the surfaces may be oblique in the circumferential direction with respect to the radial direction of the drill shank and the rotation bushing such that the axes of the transmission members are obliquely set. The details of the various embodiments set forth may be modified and used in connection with other embodiments within the scope of the inventive idea.

1. A coupling arrangement for coupling a drill shank of a rock drill unrotatably but axially movably with respect to a rotation bushing locating around the drill shank while the shank is mounted in place in the rock drill and rotating the drill shank, in which arrangement the rotation bushing comprises, in relation to the direction of rotation, at least one power transmission surface substantially in the direction of the rotation axis, transverse to the direction of rotation and facing the direction of rotation, and correspondingly, the drill shank comprises an equal number of power reception surfaces substantially in the same direction from the power transmission surfaces to the direction of rotation, and power transmission members, whereby the rotation torque is transferred during rotation from the rotation bushing through the power transmission surfaces, the transmissions members and power reception surfaces to the drill shank, wherein power transmission members are mounted rotatably between the power transmission surface and the corresponding power reception surface such that as the drill shank moves in relation to the rotation bushing in the longitudinal direction of the reception and power transmission surfaces, the transmission members rotate along the power transmission surface and correspondingly along the power reception surface.

2. The coupling arrangement of claim 1, wherein the drill shank and correspondingly the rotation bushing comprise at least one groove in their longitudinal direction such that when the drill shank is mounted in place the grooves are aligned, that in the grooves there is at least one rolling transmission member that prevents the mutual rotation of the drill shank and the rotation bushing and through which rotation torque from the rotation bushing affects the drill shank such that the drill shank rotates as the rotation bushing rotates and that, as the drill shank moves longitudinally to the rotation bushing, the transmission members rotate about axes that are transversal to the drill shank such that they roll along the surfaces of the grooves in the drill shank and the rotation bushing respectively.

3. The coupling arrangement of claim 1, wherein the drill shank and correspondingly the rotation bushing are provided in their longitudinal direction with at least one groove such that each comprises a ridge such that when the drill shank is mounted in place the ridge of the drill shank extends to the groove in the rotation bushing, and correspondingly, the ridge of the rotation bushing extends to the groove in the drill shank, that the power transmission surfaces and correspondingly the power reception surfaces are provided on the sides of the grooves and the ridges and that rolling power transmission members are placed between at least the power transmission surfaces in the direction of rotation of the rock drill and the corresponding power reception surfaces of the drill shank.

4. The coupling arrangement of claim 3, wherein the rolling transmission members are also placed between the power transmission surfaces opposite to the ridges of the rotation bushing and the power reception surface of the reversed direction of rotation of the drill shank.

5. The coupling arrangement of claim 1, wherein the rolling transmission members are round balls and that the power transmission surfaces and correspondingly the power reception surfaces are substantially circular-arch-shaped in cross section.

6. The coupling arrangement of claim 2, wherein the rolling transmission members are round balls and that the power transmission surfaces and correspondingly the power reception surfaces are substantially circular-arch-shaped in cross section and that one of the grooves in the drill shank and the rotation bushing, respectively, is such in cross section that its arch exceeds 180 degrees and that the width of the opening of the groove is smaller than the diameter of the balls.

7. The coupling arrangement of claim 1, wherein there are at least two grooves and that they are provided symmetrically in the drill shank and the rotation bushing, respectively.

8. The coupling arrangement of claim 1, wherein the rolling transmission members are cylindrical in shape and that the power reception surfaces are substantially planar.

9. The coupling arrangement of claim 1, wherein the rolling transmission members are substantially barrel-shaped and that the power transmission surfaces and correspondingly the power reception surfaces are arcuate surfaces that substantially correspond to the arcuate shape of their running surface.

10. The arrangement of claim 1, wherein between each power transmission surface and correspondingly the power reception surface there are a plurality of rolling transmission members.

11. The arrangement of claim 1, wherein the drill shank comprises, at least at the front end of the rotation bushing, a shoulder that prevents the rolling transmission members from moving away from between the drill shank and the rotation bushing, and correspondingly, at the end of the rotation bushing on the side of the percussion piston and/or at the end of the drill shank on the side of the percussion piston there is a shoulder that prevents the transmission members from moving away from between the drill shank and the rotation bushing to the side of the percussion piston.

12. The coupling arrangement of claim 10, wherein between the shoulders there are springs in the axial direction of the drill shank such that they push the transmission members towards the centre of the space between the shoulders.

13. The coupling arrangement of claim 1, wherein grooves in the drill shank extend to the end of the drill shank towards the rear end of the rock drill.

14. The coupling arrangement of claim 1, wherein grooves in the rotation bushing continue to the end of the rotation bushing towards the front end of the rock drill.

15. The coupling arrangement of claim 2, wherein the rolling transmission members are cylindrical in shape and that the power reception surfaces are substantially planar.

16. The coupling arrangement of claim 2, wherein the rolling transmission members are substantially barrel-shaped and that the power transmission surfaces and correspondingly the power reception surfaces are arcuate surfaces that substantially correspond to the arcuate shape of their running surface.

17. The coupling arrangement of claim 3, wherein the rolling transmission members are cylindrical in shape and that the power reception surfaces are substantially planar.

18. The coupling arrangement of claim 3, wherein the rolling transmission members are substantially barrel-shaped and that the power transmission surfaces
and correspondingly the power reception surfaces are arcuate surfaces that substantially correspond to the arcuate shape of their running surface.

19. The coupling arrangement of claim 4, wherein the rolling transmission members are cylindrical in shape and that the power reception surfaces are substantially planar.

20. The coupling arrangement of claim 4, wherein the rolling transmission members are substantially barrel-shaped and that the power transmission surfaces and correspondingly the power reception surfaces are arcuate surfaces that substantially correspond to the arcuate shape of their running surface.
